(19) United States
(12) Patent Application Publication
(10) Pub. No.: US 2018/0103120 A1
(43) Pub. Date: Apr. 12, 2018

(54) TECHNIQUES FOR OBTAINING AND USING DATA PACKS FOR OFFLINE PROCESSING TASKS

(71) Applicant: Google Inc., Mountain View, CA (US)

(72) Inventors: Gobind Johar, Mountain View, CA (US); Bryan Lin, Los Altos, CA (US); Masakazu Seno, Cupertino, CA (US); Scott Atwood, Campbell, CA (US)

(73) Assignee: Google Inc., Mountain View, CA (US)

(21) Appl. No.: 15/288,512

(22) Filed: Oct. 7, 2016

(51) Int. Cl. H04L 29/08

(52) U.S. Cl. CPC H04L 67/34; H04L 67/42

(57) ABSTRACT

Computer-implemented techniques include an application executing at a client computing device obtaining, from a server computing device, a list of available data packs associated with the application. The client computing device determines a set of data packs stored thereat and, using the list of available data packs, determines that a modified version of a particular data pack is available. In response to a request from the client computing device, the server computing device provides information corresponding to the modified version of the particular data pack. Upon receipt of this information, the client computing device utilizes the modified version of the particular data pack within the application and without restarting the application.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A server computing device typically has greater processing power and/or storage capabilities compared to a client computing device (e.g., a mobile phone). Complex processing tasks, therefore, are often performed at least partially by the server computing device, and the results are then provided to the client computing device. These processing tasks can include, for example, machine language translation and navigation/real-time maps. When the client computing device does not have a network connection, however, the client computing device may be unable to communicate with the server computing device. The client computing device, therefore, can perform these processing tasks locally or “offline.” The results of the processing tasks (as obtained by the client computing device), however, are typically lower quality than the results that could be obtained by the server computing device.

### SUMMARY

According to some aspects of the present disclosure, a computer-implemented method and a server computing device are presented. The server computing device can include a non-transitory computer-readable medium having a set of instructions stored thereon and one or more processors configured to execute the set of instructions, which causes the server computing device to perform the technique. The technique can include receiving, by a server computing device and from an application executing at a client computing device, a first request for a list of available data packs associated with the application; in response to the receiving the first request, transmitting, from the server computing device and to the client computing device, the list of available data packs, wherein receipt of the list of available data packs causes the client computing device to: (i) determine a set of data packs stored at the client computing device and associated with the application, each data pack including information that enables the application to perform an offline processing task, (ii) based on the set of data packs and the list of available data packs, determine that a modified version of a particular data pack of the set of data packs is available, and (iii) transmit, to the server computing device, a second request for the modified version of the particular data pack; receiving, by the server computing device and from the client computing device, the second request; and in response to receiving the second request, transmitting, from the server computing device and to the client computing device, information corresponding to the modified version of the particular data pack, wherein receipt of the information causes the client computing device to utilize the modified version of the particular data pack in the application without restarting the application.

In some implementations, the application is a translation application and the offline processing task is offline language translation, and wherein each data pack is a language pack that (i) defines translation information between two different languages and (ii) is configured to enable the client computing device to perform language translation between the two different languages. In some implementations, the particular language pack is not configured to enable the client computing device to perform language translation of an image comprising a text, and wherein the modified version of the particular language pack is configured to enable the client computing device to perform language translation of the image comprising the text. In some implementations, receipt of the information corresponding to the modified version of the particular language pack further causes the client computing device to enable a camera within the translation application, wherein the camera was previously disabled and is configured to capture the image comprising the text.

In some implementations, the information includes only a portion of the modified version of the particular language pack, and wherein receipt of the information causes the client computing device to modify the particular language pack using the information to obtain the modified version of the particular language pack; or the information includes the modified version of the language pack. In some implementations, receipt of the list of available data packs causes the client computing device to: output a prompt to a user of the client computing device as to whether to obtain the modified version of the particular language pack; and receive a response to the prompt, wherein the transmitting of the second request to the server computing device is performed based on the response.

According to some aspects of the present disclosure, another computer-implemented method and a client computing device are presented. The server computing device can include a non-transitory computer-readable medium having a set of instructions stored thereon and one or more processors configured to execute the set of instructions, which causes the client computing device to perform the technique. The technique can include launching, by a client computing device, an application; upon launching the application, transmitting, from the application and to a server computing device, a first request for a list of available data packs associated with the application; receiving, from the server computing device, the list of available data packs; determining, by the client computing device, a set of data packs stored at the client computing device and associated with the application, each data pack including information that enables the application to perform an offline processing task; based on the set of data packs and the list of available data packs, determining, by the client computing device, that a modified version of a particular data pack of the set of data packs is available; transmitting, from the client computing device and to the server computing device, a second request for the modified version of the particular data pack; receiving, by the client computing device and from the server computing device, information corresponding to the modified version of the particular data pack; and utilizing, by the client computing device, the modified version of the particular data pack in the application without restarting the application.

In some implementations, the application is a translation application and the offline processing task is offline language translation, and wherein each data pack is a language pack that (i) defines translation information between two different languages and (ii) is configured to enable the client computing device to perform language translation between the two different languages. In some implementations, the particular language pack is not configured to enable the client computing device to perform language translation of an image comprising a text, and wherein the modified version of the particular language pack is configured to enable the client computing device to perform language translation of the image comprising the text. In some implementations, the technique further comprises enabling, by the client computing device, a camera within the translation application, wherein the camera was previously disabled and is configured to capture the image comprising the text.

In some implementations, the information includes only a portion of the modified version of the particular language pack, and wherein receipt of the information causes the client computing device to modify the particular language pack using the information to obtain the modified version of the particular language pack; or the information includes the modified version of the language pack. In some implementations, the technique further comprises: outputting, by the client computing device, a prompt to a user of the client computing device as to whether to obtain the modified version of the particular language pack; and receiving, by the client computing device, a response to the prompt, wherein the transmitting of the second request to the server computing device is performed based on the response.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system according to some implementations of the present disclosure;

FIG. 2 is a functional block diagram of an example computing device according to some implementations of the present disclosure;

FIG. 3A is a flow diagram of an example first method of obtaining and using data packs for an offline processing task according to some implementations of the present disclosure;

FIG. 3B is a flow diagram of an example second method of obtaining and using data packs for an offline processing task according to some implementations of the present disclosure; and

FIGS. 4A-4C are example user interfaces for a translation application executing at a client computing device according to some implementations of the present disclosure.

### DETAILED DESCRIPTION

As previously mentioned, a client computing device may perform complex processing tasks locally or “offline” when a network connection to a server computing device is unavailable. One example processing task machine language translation where a user utilizes the client computing device (e.g., a mobile phone) to obtain text translations from the server computing device via a network. When the network connection is unavailable (due to an outage of a network, because the client computing device is not authorized for communication via the network, etc.), however, the client computing device may perform machine translation of a text from a source language to a different target language. This can also be referred to as local or offline translation. The server computing device, however, is typically a device or a system of devices configured specifically for machine translation. Thus, the server computing device typically stores a large amount of information that is used specifically for text translation. The client computing device, on the other hand, typically has a limited storage capacity and also typically is required to perform additional functionality beyond text translation.

The client computing device, therefore, can obtain one or more data packs that it can use in performing the offline processing task. The term “data pack” as used herein can refer to a file or collection of files including information that can be used to perform the offline processing task. For machine language translation, these data packs (or “language packs”) could include information relating words in two different languages It will be appreciated, however, that a language pack could include information relating words of three or more languages (e.g., two languages for the translation, and an intermediary bridge language). For navigation or real-time maps, these data packs (or “map packs”) could include map information. These data packs can be obtained by the client computing device when it can communicate with the server computing device via the network. For example, a user of the client computing device may obtain an English-French language pack prior to traveling to France because they may not have access to a network (e.g., a cellular network) during their travels, but they may still need the ability to perform English-to-French translation using their client computing device.

These data packs, however, may change over time. Specifically, these data packs may be modified such that their use enables the client computing device to obtain better quality (e.g., more accurate) results for the offline processing task. These changes or modifications to the data packs can be made, for example, based on user feedback. For example, users may provide feedback regarding the poor quality or inaccuracy of a particular word-to-word translation defined by a particular language pack, and the language pack could then be modified to define a different word-to-word translation. Alternatively, for example, users may provide feedback regarding an inaccurate landmark on a map. Because these data packs may frequently change, it may be beneficial for the client computing device to obtain the most recent data packs. For example, a modified or updated language pack may enable the client computing device to obtain translated texts from images, whereas the camera may have previously been disabled. Conventional update routines involve all stored data packs being re-downloaded, even though only a particular one may have been updated/upgraded. Certain factors, however, make the repeated download of updated data packs by the client computing device undesirable. Examples of these factors include high network data costs and client-side battery power limitations.

Accordingly, techniques are presented for obtaining and using data packs for offline processing tasks. These techniques enable the client computing device to seamlessly obtain both updates and upgrades to data packages for offline processing tasks (e.g., via a push from a server computing device). The term “update” as used herein refers to obtaining a revised or new version of a currently stored data package. In contrast, the term “upgrade” as used herein refers to obtaining a higher quality (e.g., larger) version of the currently stored data package. In other words, an update refers to obtaining a new version of the same type (e.g., low or high quality) of the currently stored data pack, whereas an upgrade refers to obtaining a higher quality version of the currently stored low quality data pack. Because these higher quality data packs are larger in size, they require additional memory and also take longer to download. For these reasons, the client computing device may not always obtain the higher quality version of a particular data package. For example, when connected to free WiFi, the client computing device may obtain the higher quality data pack, but when connected to a cellular network with data costs, the client computing device may only obtain the lower quality data pack. It will be appreciated, however, that it may be up to the user to choose when to download particular data packs (e.g., he/she may choose to download a larger, higher quality data pack over a cellular network).

While a translation application and machine language translation are specifically discussed herein, it will be appreciated that the techniques herein can be applied to any software application that utilizes data packs for performing offline processing tasks that are typically performed at least partially by a remote server computing device (e.g., due to their processing complexity and/or their associated storage requirements). As previously mentioned, one example of another such software application is a real-time map or navigation application. Other example applications could be text-to-speech (TTS) and automatic speech recognition (ASR) applications. The techniques can also be implemented at the client computing device, the server computing device, or some combination thereof. These techniques also primarily operate during periods when the client computing device has a connection to the server computing device via the network. Some operations, however, could be performed when the client computing device is not connected to the network, such as storing and configuring the data packs at the client computing device. Upon launching the application, the client computing device and the server computing device communicate to determine whether there are any available updates or upgrades to the current data packs stored at the client computing device. This can include, for example, the client computing device transmitting a first request for a list of available data packs at the server computing device, and the server computing device then returning the list of available data packs to the client computing device. For example, a user of the client computing device may have previously selected a few data packs that she/he is interested in using. These preferences could also be obtained automatically by the client computing device based on other information (a profile, a social network, a browsing history, a geo-location, etc.), provided the user has provided his/her permission, which is discussed in greater detail below.

When there are updates or upgrades available, the client computing device can notify a user via the application. For example, an icon may appear that the user must select in order to initiate the download. The updates and upgrades can also be performed automatically without user input, depending on various conditions (e.g., user preferences). For example, when connected to a cellular network having data costs, updates may be obtained automatically, but upgrades may require user approval. When connected to a free WiFi network, on the other hand, both updates and upgrades could be obtained automatically. After downloading the update or upgrade, the translation application is able to use it for performing language translation. Because these data packs are separate files, the application is able to utilize the updated or upgraded language packages without restarting. Operation of the application may also change upon obtaining the modified language pack(s), such as the enabling of a previously-disabled camera for image-based translation (e.g., in response to receiving an upgraded language pack that enables the client computing device to perform image-based translation). Image-based translation can refer to extracting a text from an image (e.g., using optical character recognition, or OCR) and then translating the extracted text from its source language to a different target language. Other examples of additional functionality provided by upgraded or higher quality data packs include offline handwriting recognition (HWR), offline TTS, and offline voice recognition or ASR.

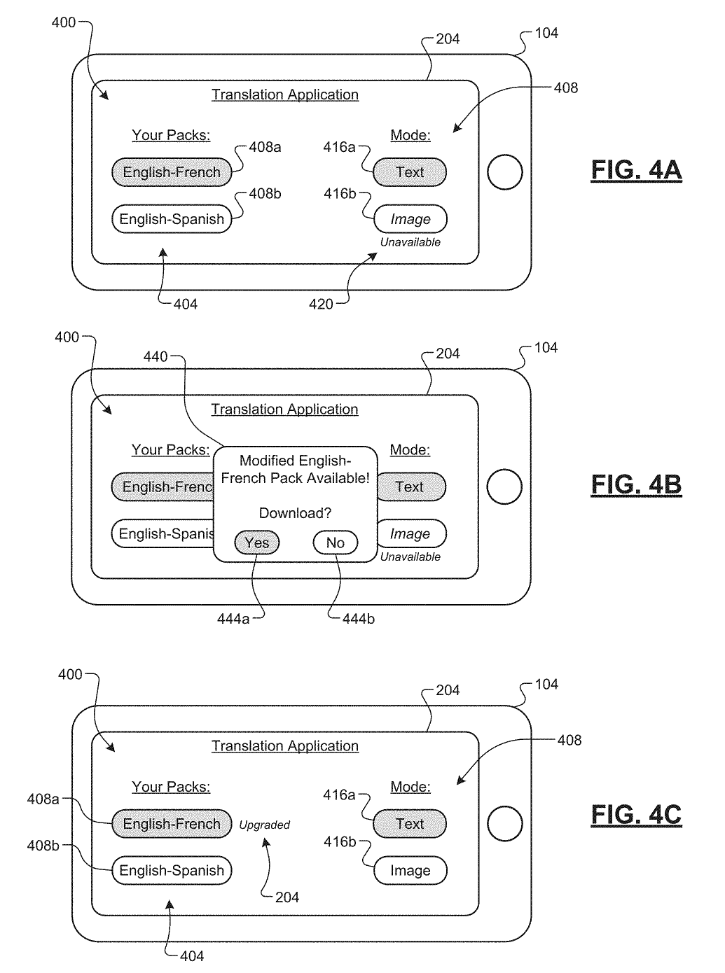

As mentioned, at least a portion of the techniques of the present disclosure could be at least partially implemented by an application (e.g., a translation application) executing at a client computing device. This application could be, for example only, a standalone application. Non-limiting example user interfaces are discussed herein and illustrated in FIGS. 4A-4C with respect to an example translation application. Additionally or alternatively, these techniques could be at least partially implemented at an operating system level at the client computing device. Further, at least a portion of these techniques could be implemented at the server computing device (e.g., the data pack version comparing and serving to the client computing device). The server computing device could, for example, provide the client computing device with a list of the most updated/upgraded language packs and, upon the client computing device determining that a modified version of a particular data pack is available, the client computing device could obtain the modified version of the data pack or corresponding information from the server computing device. It will be appreciated that the data packs could also be stored at a different server computing device, and the server computing device discussed herein could act as an intermediary between the client computing device and the other server computing device.

The present disclosure is directed to, inter alia, the technical problem of performing accurate, offline processing. More specifically, the present disclosure is directed to techniques for obtaining data packs that can be utilized by a client computing device to obtain accurate results for an offline processing task during periods when the client computing device is unable to communicate with a server computing device via a network. One benefit of these techniques is the ease and simplicity of obtaining of more accurate data packs that can be utilized by a local application in performing a particular offline processing task. Another benefit of these techniques is the ability of the application to utilize the recently-obtained data packs without having to restart itself, thereby saving users time. The techniques utilize various hardware components (e.g., a transceiver, processor(s), memory, and a touch display) to determine whether a modified version of a particular data pack is available and, if so, to seamlessly obtain and utilize the modified version of the particular data pack without restarting the application.

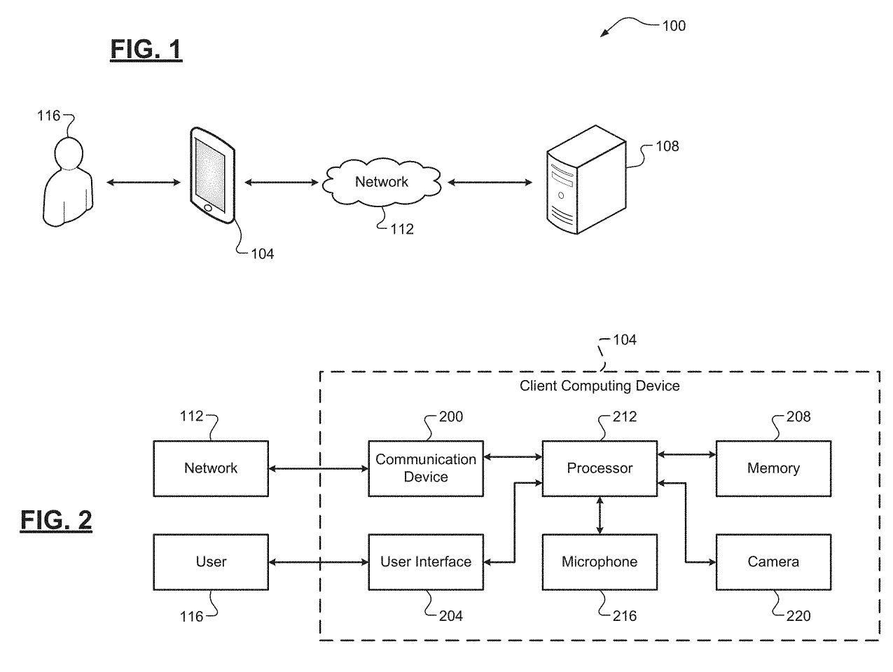

Referring now to FIG. 1, an example computing system 100 according to some implementations of the present disclosure is illustrated. The computing system 100 can include a client computing device 104 that can communicate with a server computing device 108 via a network 112. The network 112 can be a local area network (LAN), a wide area network (WAN), e.g., the Internet, or a combination thereof. While the client computing device 104 is shown to be a mobile phone, it will be appreciated that the client computing device 104 can be any suitable mobile computing device (a tablet computer, a laptop computer, etc.). The server computing device 108 can be any suitable hardware server or plurality of hardware servers operating in a parallel or distributed architecture. A user 116 can operate the client computing device 104, such as by providing text inputs (e.g., via a physical/virtual keyboard or a microphone) for language translation, capturing images comprising text for language translation, and/or responding to prompts from the server computing device.

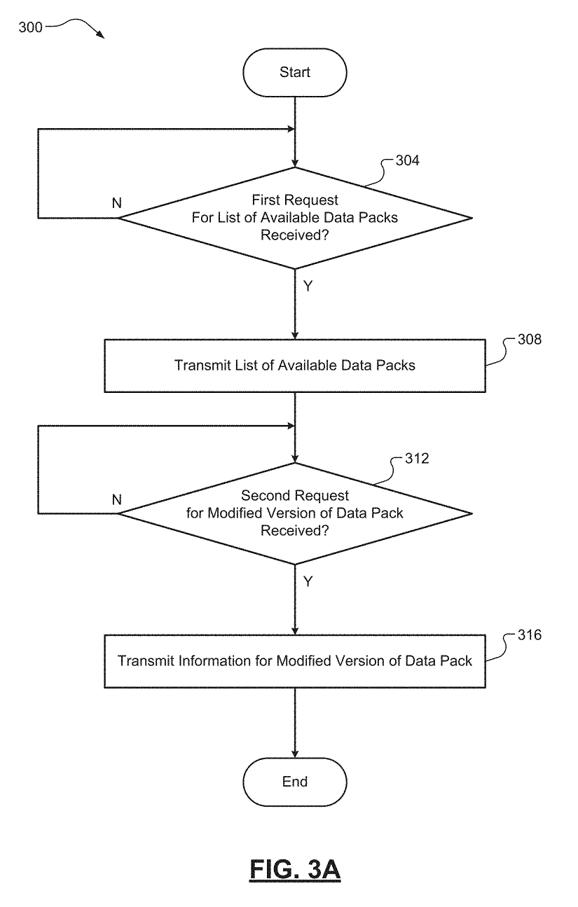

Referring now to FIG. 2, an example configuration for the client computing device 104 is illustrated. The server computing device 108 can have the same or similar configuration as the client computing device 104. The client computing device 104 can include a communication device 200 (e.g., a transceiver) configured for communication via the network 112. The client computing device 104 can include a user interface 204 (e.g., a touch display) configured to receive input and/or output information from/to the user 116. The client computing device 104 can include a non-transitory computer-readable medium or computer memory 208 (flash, hard disk, etc.) configured to store information (e.g., language packs) at the client computing device 104. The client computing device 104 can also include a processor 212 configured to control operation of the client computing device 104. The term “processor” as used herein can refer to both a single processor and a plurality of processors operating in a parallel or distributed architecture. In one implementation, the memory 208 may store a set of instructions that, when executed by the processor 212, causes the client computing device 104 to perform at least a portion of the techniques herein. The client computing device 104 can also include other devices, such as a microphone 216 and a camera 220 configured to capture audio data and video data, respectively. The client computing device 104 could also include other components, such as a global positioning satellite (GPS) transceiver (not shown) configured to communicate with a GPS system (not shown) for location/position information.

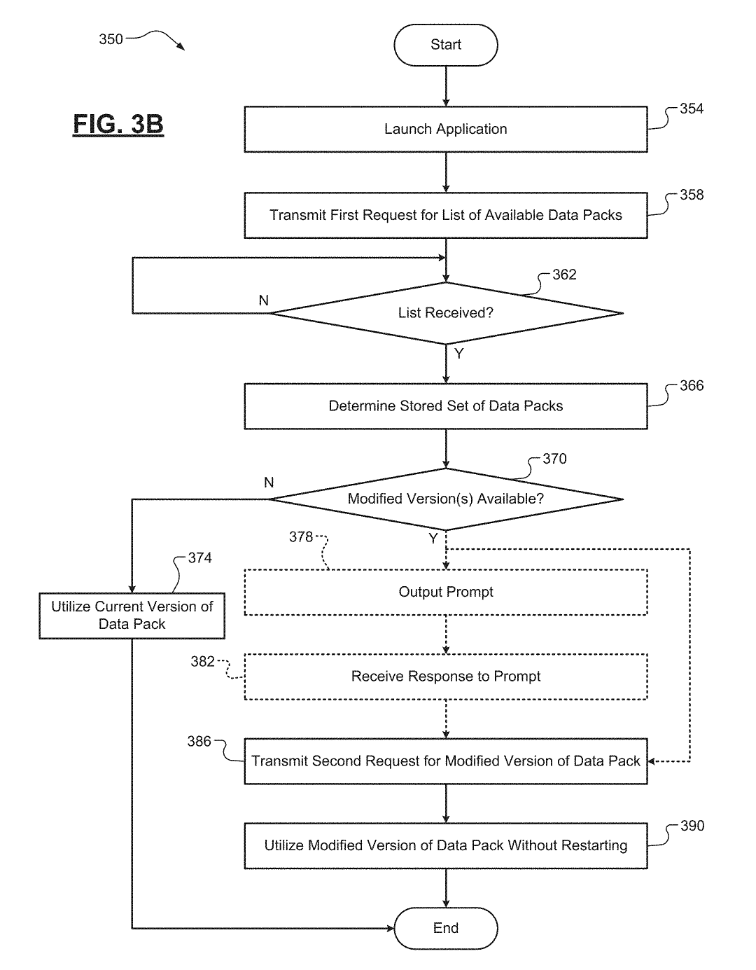

Referring now to FIG. 3A, a flow diagram of an example first method 300 of obtaining and using data packs for an offline processing task is illustrated. At 304, the server computing device 108 can determine whether a first request has been received from the application executing at the client computing device 104. The first request can be for a list of available data packs associated with the application (e.g., a manifest file). If true, the method 300 can proceed to 308. Otherwise, the method 300 can end or return to 304. At 308, the server computing device 108 can transmit, to the client computing device 104, the list of available data packs. Receipt of this list can cause the client computing device 104 to compare its set of stored data packs to the list of available data packs to identify a modified version of a particular data pack. FIGS. 4A-4C illustrate an example user interface 400 of a translation application. As shown, a set 404 of currently stored language packs includes an English-French language pack 408a (currently selected) and an English-Spanish language pack 408b. A set 408 of available translation modes for the selected English-French language pack 408a shows that text translation 416a is available but image-based translation 416b is unavailable as indicated by text 420, e.g., because the client computing device 104 only has a lower quality version of the English-French language pack that does not enable it to perform image-based offline translation.

In other implementations, the server computing device 108 could also have previously learned and stored the most-recent version(s) of the data pack(s) stored by the client computing device 104, such as during a previous communication session. Thus, this further communication with the client computing device 104 may not be required, which could save on data costs. At 312, the server computing device 108 can determine whether a second request for the modified version of the particular data pack has been received from the client computing device 104. If true, the method 300 can proceed to 316. Otherwise, the method 300 can end or return to 312. For example, the client computing device 104 could have determined that an updated version of a particular data pack is available (e.g., for version 6.0 when the client computing device 104 only has version 5.0). Each language pack, for example, (i) can define translation information between two different languages and (ii) can be configured to enable the client computing device 104 to perform language translation between the two different languages.

In some implementations, receipt of the list of available data packs can cause the client computing device 104 to output a prompt to its user 116 as to whether to obtain the modified version of the particular data pack. Alternatively, the modified version of the particular data pack could be obtained automatically without user input or approval. As shown in FIG. 4B, the client computing device 104 can output a prompt 440 to the user 116 (e.g., a pop-up window) asking whether the user 116 would like to download the modified English-French language pack. As shown, the user 116 has selected icon 444a (“Yes”) as opposed to icon 444b (“No”), which can cause the client computing device 104 to transmit the second request to the server computing device 108. At 316, the server computing device 108 can transmit, to the client computing device 104, information corresponding to the modified version of the particular data pack. Receipt of the information causes the client computing device 104 to utilize the modified version of the particular data pack in the application without restarting the application. Depending on whether an update or an upgrade is obtained, the received information can be a partial file or a new file. This information could also be information regarding a location of where to download the partial or new file, such as a uniform resource locator (URL). When an upgrade is performed (e.g., a higher quality data pack is obtained), the previously-stored data pack (e.g., a lower quality data pack) may be kept instead of being discarded. For example, the lower quality data pack could still be utilized for easier or less complex processing tasks because its use could save battery power compared to using the higher quality data pack. For updates, on the other hand, the modified version of the particular data pack may overwrite or replace the previously-stored version of the particular data pack.

In some machine language translation implementations, the particular language pack is not configured to enable the client computing device 104 to perform language translation of an image comprising a text or image-based translation. In these cases, the modified version of the particular language pack may be configured to enable the client computing device 104 to perform language translation of the image comprising the text. Receipt of this upgraded version of the particular language pack may cause the client computing device 104 to enable a camera within the translation application, wherein the camera was previously disabled and is configured to capture the image comprising the text. As shown in FIGS. 4A-4B, image-based translation may have been previously unavailable or disabled because the client computing device 104 has a lower quality English-French language pack. Upon receiving the upgraded English-French language pack, however, image-based translation can be enabled as is shown in FIG. 4C (e.g., the user 116 could then select icon/button 416b to enable image-based translation mode) . For example only, a camera icon or button could have been previously unavailable or greyed out, but could then subsequently be enabled or activated upon receipt of the upgraded version of the particular language pack. Text 448 or another indication can also be provided to notify the user 116 of which language packs have been updated/upgraded.

Referring now to FIG. 3B and with continued reference to FIGS. 4A-4C, a flow diagram of an example second method 350 of obtaining and using data packs for offline processing tasks is illustrated. At 354, the client computing device 104 launches the application. The application could be launched, for example, in response to an input from the user 116. The application could also be launched, for example, upon startup of the client computing device 104. Upon launching the application, the client computing device 104 can transmit, to the server computing device 108, a first request for a list of available data packs associated with the application at 358. At 362, the client computing device 104 can receive the list of available data packs from the server computing device 108. At 366, the client computing device 104 determines a set of data packs that it has stored and that are associated with the application. At 370, the client computing device 104 can determine whether a modified version of a particular data pack is available based on a comparison between its set of data packs and the list of available data packs. When available, the method 350 can proceed to 378. Otherwise, the client computing device 104 can continue utilizing the current version of the particular data pack at 374 and the method 350 can then end.

At 378, the client computing device 104 can output a prompt (e.g., prompt 440) to the user 116. At 382, the client computing device 104 can receive a response (e.g., “Yes”) and, based on the response, can transmit the second request to the server computing device 108 at 386. The server computing device 108 can then, based on the response, transmit information for the modified version of the language pack to the client computing device 104, which is received at 386. Steps 378 and 382 may be optional. More specifically, the modified version of the particular data pack could be obtained automatically and without user input or approval. As previously discussed herein, this information could be a partial update (only a portion of a new version of the same type of the particular data pack), a full update (the full new version of the same type of the particular data pack), or an upgrade (a better, different type of the particular data pack). At 390, the client computing device 104 can utilize the modified version of the particular data pack (received or obtained using the partial update) in performing the offline processing task. The method 350 can then end or return to 354.

One or more systems and methods discussed herein do not require collection or usage of user personal information. In situations in which certain implementations discussed herein may collect or use personal information about users (e.g., user data, information about a user's social network, user's location and time, user's biometric information, user's activities and demographic information), users are provided with one or more opportunities to control whether the personal information is collected, whether the personal information is stored, whether the personal information is used, and how the information is collected about the user, stored and used. That is, the systems and methods discussed herein collect, store and/or use user personal information only upon receiving explicit authorization from the relevant users to do so. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, by a server computing device and from an application executing at a client computing device, a first request for a list of available data packs associated with the application;
in response to the receiving the first request, transmitting, from the server computing device and to the client computing device, the list of available data packs, wherein receipt of the list of available data packs causes the client computing device to:
(i) determine a set of data packs stored at the client computing device and associated with the application, each data pack including information that enables the application to perform an offline processing task,
(ii) based on the set of data packs and the list of available data packs, determine that a modified version of a particular data pack of the set of data packs is available, and
(iii) transmit, to the server computing device, a second request for the modified version of the particular data pack;
receiving, by the server computing device and from the client computing device, the second request; and
in response to receiving the second request, transmitting, from the server computing device and to the client computing device, information corresponding to the modified version of the particular data pack, wherein receipt of the information causes the client computing device to utilize the modified version of the particular data pack in the application without restarting the application.

2. The computer-implemented method of claim 1, wherein the application is a translation application and the offline processing task is offline language translation, and wherein each data pack is a language pack that (i) defines translation information between two different languages and (ii) is configured to enable the client computing device to perform language translation between the two different languages.

3. The computer-implemented method of claim 2, wherein the particular language pack is not configured to enable the client computing device to perform language translation of an image comprising a text, and wherein the modified version of the particular language pack is configured to enable the client computing device to perform language translation of the image comprising the text.

4. The computer-implemented method of claim 3, wherein receipt of the information corresponding to the modified version of the particular language pack further causes the client computing device to enable a camera within the translation application, wherein the camera was previously disabled and is configured to capture the image comprising the text.

5. The computer-implemented method of claim 2, wherein:
the information includes only a portion of the modified version of the particular language pack, and wherein receipt of the information causes the client computing device to modify the particular language pack using the information to obtain the modified version of the particular language pack; or
the information includes the modified version of the language pack.

6. The computer-implemented method of claim 2, wherein receipt of the list of available data packs causes the client computing device to:
output a prompt to a user of the client computing device as to whether to obtain the modified version of the particular language pack; and
receive a response to the prompt, wherein the transmitting of the second request to the server computing device is performed based on the response.

7. A server computing device, comprising:
a non-transitory computer-readable medium having a set of instructions stored thereon; and
one or more processors configured to execute the set of instructions, which causes the server computing device to perform operations comprising:
receiving, from an application executing at a client computing device, a first request for a list of available data packs associated with the application;
in response to the receiving the first request, transmitting, to the client computing device, the list of available data packs, wherein receipt of the list of available data packs causes the client computing device to:
(i) determine a set of data packs stored at the client computing device and associated with the application, each data pack including information that enables the application to perform an offline processing task,
(ii) based on the set of data packs and the list of available data packs, determine that a modified version of a particular data pack of the set of data packs is available, and
(iii) transmit, to the server computing device, a request for the modified version of the particular data pack;
receiving, from the client computing device, the second request; and
in response to receiving the second request, transmitting, to the client computing device, information corresponding to the modified version of the particular data pack, wherein receipt of the information causes the client computing device to utilize the modified version of the particular data pack in the application without restarting the application.

8. The server computing device of claim 7, wherein the application is a translation application and the offline processing task is offline language translation, and wherein each data pack is a language pack that (i) defines translation information between two different languages and (ii) is configured to enable the client computing device to perform language translation between the two different languages.

9. The server computing device of claim 8, wherein the particular language pack is not configured to enable the client computing device to perform language translation of an image comprising a text, and wherein the modified version of the particular language pack is configured to enable the client computing device to perform language translation of the image comprising the text.

10. The server computing device of claim 9, wherein receipt of the information corresponding to the modified version of the particular language pack further causes the client computing device to enable a camera within the translation application, wherein the camera was previously disabled and is configured to capture the image comprising the text.

11. The server computing device of claim 8, wherein:
the information includes only a portion of the modified version of the particular language pack, and wherein receipt of the information causes the client computing device to modify the particular language pack using the information to obtain the modified version of the particular language pack; or
the information includes the modified version of the language pack.

12. The server computing device of claim 8, wherein receipt of the list of available data packs causes the client computing device to:
output a prompt to a user of the client computing device as to whether to obtain the modified version of the particular language pack; and
receive a response to the prompt, wherein the transmitting of the second request to the server computing device is performed based on the response.

13. A computer-implemented method, comprising:
launching, by a client computing device, an application;
upon launching the application, transmitting, from the application and to a server computing device, a first request for a list of available data packs associated with the application;
receiving, from the server computing device, the list of available data packs;
determining, by the client computing device, a set of data packs stored at the client computing device and associated with the application, each data pack including information that enables the application to perform an offline processing task;
based on the set of data packs and the list of available data packs, determining, by the client computing device, that a modified version of a particular data pack of the set of data packs is available;
transmitting, from the client computing device and to the server computing device, a second request for the modified version of the particular data pack;
receiving, by the client computing device and from the server computing device, information corresponding to the modified version of the particular data pack; and
utilizing, by the client computing device, the modified version of the particular data pack in the application without restarting the application.

14. The computer-implemented method of claim 13, wherein the application is a translation application and the offline processing task is offline language translation, and wherein each data pack is a language pack that (i) defines translation information between two different languages and (ii) is configured to enable the client computing device to perform language translation between the two different languages.

15. The computer-implemented method of claim 14, wherein the particular language pack is not configured to enable the client computing device to perform language translation of an image comprising a text, and wherein the modified version of the particular language pack is configured to enable the client computing device to perform language translation of the image comprising the text.

16. The computer-implemented method of claim 15, further comprising enabling, by the client computing device, a camera within the translation application, wherein the camera was previously disabled and is configured to capture the image comprising the text.

17. The computer-implemented method of claim 14, wherein:
the information includes only a portion of the modified version of the particular language pack, and wherein receipt of the information causes the client computing device to modify the particular language pack using the information to obtain the modified version of the particular language pack; or
the information includes the modified version of the language pack.

18. The computer-implemented method of claim 14, further comprising:
outputting, by the client computing device, a prompt to a user of the client computing device as to whether to obtain the modified version of the particular language pack; and
receiving, by the client computing device, a response to the prompt, wherein the transmitting of the second request to the server computing device is performed based on the response.

19. A client computing device, comprising:
a non-transitory computer-readable medium having a set of instructions stored thereon; and
one or more processors configured to execute the set of instructions, which causes the client computing device to perform operations comprising:
launching an application;
upon launching the application, transmitting, from the application and to a server computing device, a first request for a list of available data packs associated with the application;
receiving, from the server computing device, the list of available data packs;
determining a set of data packs stored at the client computing device and associated with the application, each data pack including information that enables the application to perform an offline processing task;
based on the set of data packs and the list of available data packs, determining that a modified version of a particular data pack of the set of data packs is available;
transmitting, to the server computing device, a second request for the modified version of the particular data pack;
receiving, from the server computing device, information corresponding to the modified version of the particular data pack; and
utilizing the modified version of the particular data pack in the application without restarting the application.

20. The client computing device of claim 19, wherein the application is a translation application and the offline processing task is offline language translation, and wherein each data pack is a language pack that (i) defines translation information between two different languages and (ii) is configured to enable the client computing device to perform language translation between the two different languages.

21. The client computing device of claim 20, wherein the particular language pack is not configured to enable the client computing device to perform language translation of an image comprising a text, and wherein the modified version of the particular language pack is configured to enable the client computing device to perform language translation of the image comprising the text.

22. The client computing device of claim 21, wherein the operations further comprise enabling a camera within the translation application, wherein the camera was previously disabled and is configured to capture the image comprising the text.

23. The client computing device of claim 20, wherein:
the information includes only a portion of the modified version of the particular language pack, and wherein receipt of the information causes the client computing device to modify the particular language pack using the information to obtain the modified version of the particular language pack; or
the information includes the modified version of the language pack.

24. The client computing device of claim 14, wherein the operations further comprise:
outputting a prompt to a user of the client computing device as to whether to obtain the modified version of the particular language pack; and
receiving a response to the prompt, wherein the transmitting of the second request to the server computing device is performed based on the response.
